(19) United States
(12) Patent Application Publication
(10) Pub. No.: US 2026/0149982 A1
(43) Pub. Date: May 28, 2026

(54) CONTROL SYSTEM, CONTROL APPARATUS, CONTROL METHOD, AND NON-TRANSITORY COMPUTER READABLE MEDIUM

(71) Applicant: NEC Corporation, Minato-ku, Tokyo (JP)

(72) Inventors: Takeo ONISHI, Tokyo (JP); Eiji TAKAHASHI, Tokyo (JP); Yoshiaki NISHIKAWA, Tokyo (JP); Kenji KAWAGUCHI, Tokyo (JP); Yoshinori WATANABE, Tokyo (JP); Masayuki UEDA, Tokyo (JP); Hideki KOZUKA, Tokyo (JP); Rumi MATSUMURA, Tokyo (JP); Katsunori DATE, Tokyo (JP)

(73) Assignee: NEC Corporation, Minato-ku, Tokyo (JP)

(21) Appl. No.: 19/122,813

(22) PCT Filed: Nov. 8, 2022
(86) PCT No.: PCT/JP2022/041483

§ 371 Date: Apr. 21, 2025

(51) Int. Cl. H04W 24/02

(52) U.S. Cl. CPC H04W 24/02

(57) ABSTRACT

A control system (10) includes a first identification unit (11) for identifying, by a first identification model, first control information for controlling a wireless network, a second identification unit (12) for identifying, by a second identification model, second control information for controlling the wireless network, a validity determination unit (13) for determining validity of the first control information according to communication performance of the wireless network predicted based on the first control information, and a selection unit (14) for selecting control information for controlling the wireless network from the first control information and the second control information according to a determination result of the validity.

### TECHNICAL FIELD

The present disclosure relates to a control system, a control apparatus, a control method, a control program, and a non-transitory computer readable medium.

### BACKGROUND ART

In recent years, artificial intelligence (AI)/machine learning (ML) has been utilized to realize optimum control in various control systems. As related techniques, for example, Patent Literature 1 and Non-Patent Literature 1 are known.

Patent Literature 1 describes a radio access network (RAN) intelligent controller (RIC) that performs intelligent control by utilizing AI/ML in an open RAN (O-RAN) that opens the RAN. In addition, Non-Patent Literature 1 summarizes guidelines on quality control of machine learning.

### CITATION LIST

### Patent Literature

Patent Literature 1: Japanese Unexamined Patent Application Publication No. 2022-105306

### Non-Patent Literature

Non-Patent Literature 1: National Institute of Advanced Industrial Science and Technology, “Machine Learning Quality Management Guideline”, Second Edition (revision 2.1.0), Jul. 5, 2021, DigiARC-TR-2021-01/CPSEC-TR-2021001, [online], Internet, <https://www.digiarc.aist.go.jp/publication/aiqm/AIQM-Guideline-2.1.0.pdf>

### SUMMARY OF INVENTION

### Technical Problem

As described in Non-Patent Literature 1, a model generated by machine learning does not necessarily guarantee a stable operation. Therefore, in a case where control is performed using a model such as machine learning in a control system such as an O-RAN RIC, it is desired to realize stable control.

In view of such problems, an object of the present disclosure is to provide a control system, a control apparatus, a control method, a control program, and a non-transitory computer readable medium capable of performing stable control.

### Solution to Problem

A control system according to the present disclosure includes: a first identification means for identifying, by a first identification model, first control information for controlling a wireless network; a second identification means for identifying, by a second identification model, second control information for controlling the wireless network; a validity determination means for determining validity of the first control information according to communication performance of the wireless network predicted based on the first control information; and a selection means for selecting control information for controlling the wireless network from the first control information and the second control information according to a determination result of the validity.

A control apparatus according to the present disclosure includes: a first identification means for identifying, by a first identification model, first control information for controlling a wireless network; a second identification means for identifying, by a second identification model, second control information for controlling the wireless network; a validity determination means for determining validity of the first control information according to communication performance of the wireless network predicted based on the first control information; and a selection means for selecting control information for controlling the wireless network from the first control information and the second control information according to a determination result of the validity.

A control method according to the present disclosure includes: identifying, by a first identification model, first control information for controlling a wireless network; identifying, by a second identification model, second control information for controlling the wireless network; determining validity of the first control information according to communication performance of the wireless network predicted based on the first control information; and selecting control information for controlling the wireless network from the first control information and the second control information according to a determination result of the validity.

A non-transitory computer-readable medium according to the present disclosure is a non-transitory computer-readable medium storing a control program for causing a computer to execute: identifying, by a first identification model, first control information for controlling a wireless network; identifying, by a second identification model, second control information for controlling the wireless network; determining validity of the first control information according to communication performance of the wireless network predicted based on the first control information; and selecting control information for controlling the wireless network from the first control information and the second control information according to a determination result of the validity.

### ADVANTAGEOUS EFFECTS OF INVENTION

According to the present disclosure, it is possible to provide a control system, a control apparatus, a control method, a control program, and a non-transitory computer readable medium capable of performing stable control.

### BRIEF DESCRIPTION OF DRAWINGS

FIG. 1 is a configuration diagram illustrating an outline of a control system according to an example embodiment.

FIG. 2 is a configuration diagram illustrating a configuration example of a control apparatus according to the example embodiment.

FIG. 3 is a configuration diagram illustrating another configuration example of the control apparatus according to the example embodiment.

FIG. 4 is a flowchart illustrating an outline of a control method according to an example embodiment.

FIG. 5 is a configuration diagram illustrating a configuration example of a RAN system according to a first example embodiment.

FIG. 6 is a configuration diagram illustrating a basic configuration example of a Near-RT RIC and an E2 node according to the first example embodiment.

FIG. 7 is a configuration diagram illustrating a specific configuration example of the Near-RT RIC according to the first example embodiment.

FIG. 8 is a flowchart illustrating an operation example of the Near-RT RIC according to the first example embodiment.

FIG. 9 is a diagram for explaining an example of handover control according to the first example embodiment.

FIG. 10 is a diagram for explaining an example of the handover control according to the first example embodiment.

FIG. 11 is a diagram for explaining an example of beam control according to the first example embodiment.

FIG. 12 is a configuration diagram illustrating a basic configuration example of a Near-RT RIC and an E2 node according to a second example embodiment.

FIG. 13 is a configuration diagram illustrating a specific configuration example of the Near-RT RIC according to the second example embodiment.

FIG. 14 is a configuration diagram illustrating a specific configuration example of a Near-RT RIC according to a third example embodiment.

FIG. 15 is a configuration diagram illustrating a specific configuration example of a Near-RT RIC according to a fourth example embodiment.

FIG. 16 is a configuration diagram illustrating an outline of hardware of a computer according to an example embodiment.

### EXAMPLE EMBODIMENT

Hereinafter, example embodiments will be described with reference to the drawings. In the drawings, the same elements are denoted by the same reference signs, and redundant description will be omitted as necessary.

As described in Non-Patent Literature 1, a method for performing quality control and guarantee of machine learning is in the process of development. The machine learning model can output an appropriate result for a sufficiently trained input, but takes an unstable behavior for an insufficiently trained input, and thus it is not guaranteed to obtain an assumed result. As a method of solving this problem, for example, a method of increasing a variation of training data by adding noise to the training data, a method of artificially creating the training data to increase the coverage of the training data, a method of using a machine learning model capable of explaining an inference result, and the like can be considered.

However, in these methods, stability of a machine learning model can be increased to some extent, but it is not possible to stop the runaway of the machine learning model, that is, the unstable behavior with respect to the insufficiently trained input. For example, in a case where high reliability is required as in a system that controls an automatic guided vehicle (AGV), a robot, or the like, it is difficult to ensure required quality. Therefore, in the example embodiment, even in a case where inference accuracy of machine learning is insufficient due to insufficient training or the like, stable control can be performed.

### Outline of Example Embodiment

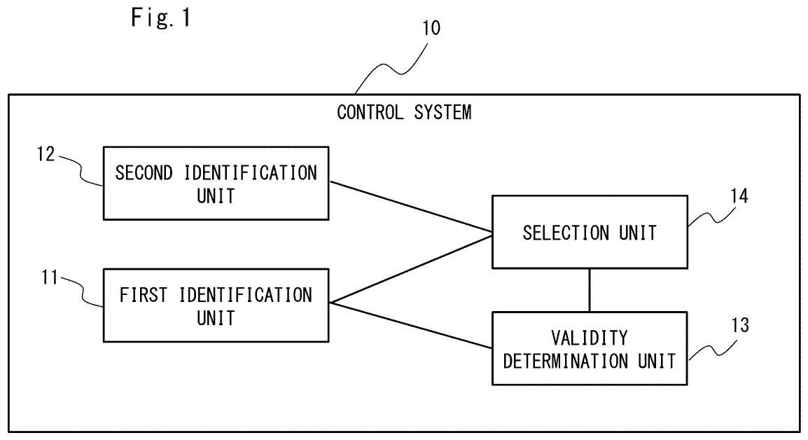

First, an outline of an example embodiment will be described. FIG. 1 illustrates a schematic configuration of a control system 10 according to the example embodiment. For example, the control system 10 constitutes a system that controls a wireless network such as a RAN. For example, the control system 10 may include, but is not limited to, either or both of Near-RT RIC and Non-RT RIC.

As illustrated in FIG. 1, the control system 10 includes a first identification unit 11, a second identification unit 12, a validity determination unit 13, and a selection unit 14.

The first identification unit 11 identifies, by a first identification model, first control information for controlling the wireless network. The second identification unit 12 identifies, by a second identification model, second control information for controlling the wireless network. The first and second identification models are included in the control system 10, for example, but may be disposed outside the control system 10. For example, the first identification model is a training model obtained by machine learning of control information according to wireless quality information acquired from a wireless network. In addition, the second identification model is a model in which reliability of the control information to be identified is higher than that of the first identification model. The highly reliable model is a model that can output stable control information over a longer time, that is, does not output abnormal control information. In other words, the second identification model has a lower probability of outputting abnormal control information than the first identification model. For example, the second identification model may identify the second control information based on a predetermined rule, or may identify the second control information by theoretical calculation or simulation. In addition, the second identification model may be a training model obtained by machine learning of the control information according to the wireless quality information acquired from the wireless network.

The validity determination unit 13 determines validity of the first control information according to communication performance of the wireless network predicted based on the first control information identified by the first identification model. That is, the validity determination unit 13 predicts the communication performance of the wireless network in a case where the wireless network is controlled by the first control information. The validity determination unit 13 may predict the communication performance of the wireless network according to the first control information by the prediction model. For example, the prediction model may predict the communication performance by theoretical calculation or simulation, or may predict the communication performance based on a predetermined rule. Furthermore, the prediction model may be a training model obtained by machine learning of communication performance according to the first control information.

The selection unit 14 selects the control information for controlling the wireless network from the first control information and the second control information according to the determination result of the validity of the first control information by the validity determination unit 13. That is, the selection unit 14 selects control information to be transmitted to the wireless network. For example, in a case where the first control information is determined to be invalid, the selection unit 14 switches the control information to be transmitted to the wireless network from the first control information to the second control information.

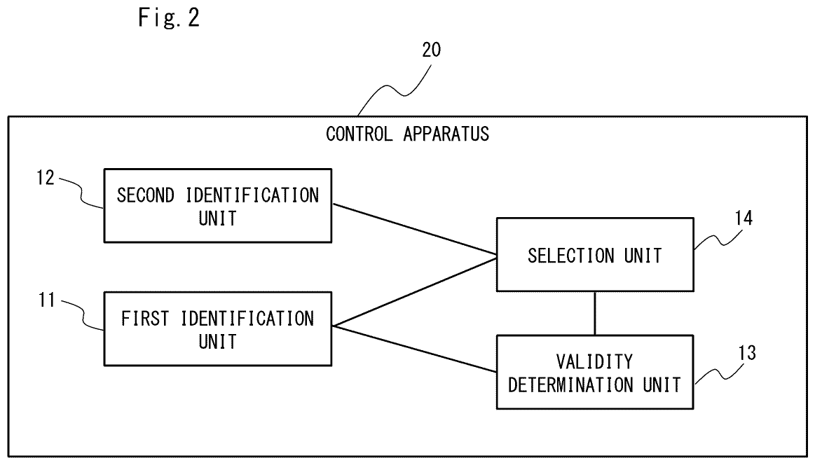

Note that the control system 10 may include one apparatus or a plurality of apparatuses. FIG. 2 illustrates a configuration example of a control apparatus according to the example embodiment. As illustrated in FIG. 2, a control apparatus 20 may include the first identification unit 11, the second identification unit 12, the validity determination unit 13, and the selection unit 14 illustrated in FIG. 1. For example, the control apparatus 20 may be either a Near-RT RIC or a Non-RT RIC.

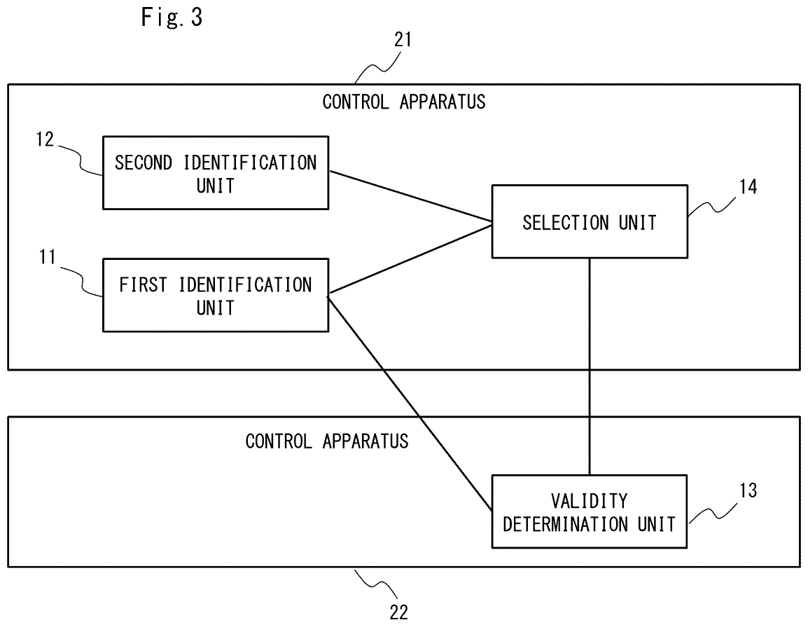

FIG. 3 illustrates another configuration example of the control apparatus according to the example embodiment. As illustrated in FIG. 3, a control apparatus 21 may include the first identification unit 11, the second identification unit 12, and the selection unit 14, and a control apparatus 22 may include the validity determination unit 13. The control apparatus 21 may be a Near-RT RIC, and the control apparatus 22 may be a Non-RT RIC.

In addition, a part or all of the control system 10 may be disposed on an edge or a cloud using a virtualization technology or the like. A part or all of the control system 10 may be disposed at an identified location, or may be dispersedly disposed at a plurality of locations. The edge is a location or infrastructure on a base station side, and the cloud is a location or infrastructure on a core network side away from the base station. For example, the first identification unit 11, the second identification unit 12, and the selection unit 14 may be disposed at an edge, and the validity determination unit 13 may be disposed in a cloud. In addition, the first identification unit 11, the second identification unit 12, the validity determination unit 13, and the selection unit 14 may be disposed in a distributed manner.

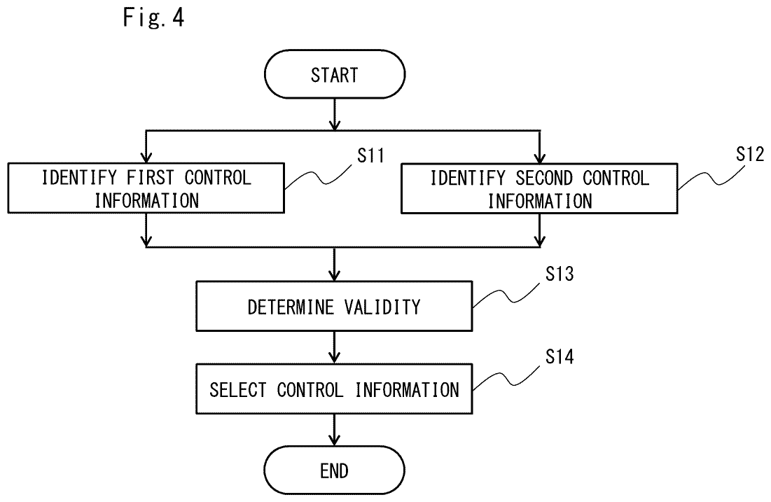

FIG. 4 illustrates a control method according to an example embodiment. For example, the control method in FIG. 4 is executed by the control system 10 in FIG. 1, the control apparatus 20 in FIG. 2, and the control apparatuses 21 and 22 in FIG. 3.

As illustrated in FIG. 4, the first identification unit 11 identifies, by the first identification model, the first control information for controlling the wireless network (S11), and the second identification unit 12 identifies, by the second identification model, the second control information for controlling the wireless network (S12). Note that S11 and S12 may be executed in parallel, or may be executed in the order of S11 to S12, or vice versa. Next, the validity determination unit 13 determines validity of the first control information according to the communication quality of the wireless network predicted based on the first control information identified by the first identification model (S13). Next, the selection unit 14 selects the control information for controlling the wireless network from the first control information and the second control information according to the determination result of the validity of the first control information (S14).

As described above, in the example embodiment, the communication quality of the wireless network is predicted from the first control information identified by the first identification model such as the machine learning model, and the validity of the first control information is determined according to the predicted communication quality. Furthermore, control information to be used for control of the wireless network is selected according to a determination result of validity of the first control information. As a result, for example, even in a case where the machine learning model takes an unstable behavior with respect to an input that is not sufficiently trained, it is possible to select control information of another model, and thus, it is possible to stably control the wireless network.

### First Example Embodiment

Next, a first example embodiment will be described. In the present example embodiment, an example in which validity of the control information identified by the machine learning model is determined and the control information for controlling the RAN is switched will be described. Note that, in the present example embodiment, an example in which wireless control is performed in the O-RAN will be described as an example, but the present example embodiment may be applied to a control system that performs other control.

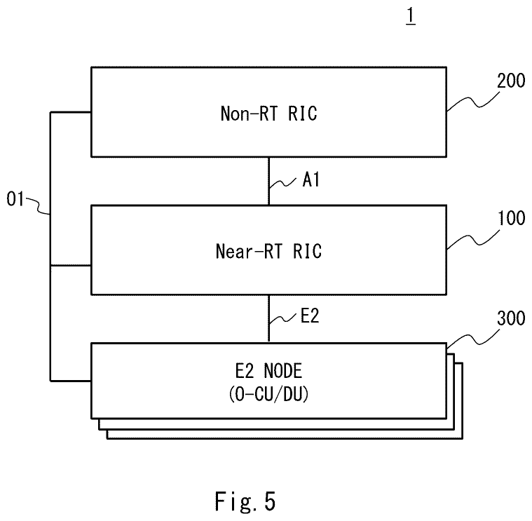

FIG. 5 illustrates a configuration example of a RAN system 1 according to the present example embodiment. As illustrated in FIG. 5, the RAN system 1 includes a Near-RT RIC 100, a Non-RT RIC 200, and an E2 node 300.

The Non-RT RIC 200 and the Near-RT RIC 100 are communicably connected to each other, and the Non-RT RIC 200 and the E2 node 300 are communicably connected to each other via an O1 interface. The O1 interface is an interface for transmitting and receiving data and messages mainly necessary for operation and management. Note that the interface is a connection interface defined by a communication protocol for transmitting and receiving data and messages, and includes a logical transmission path, a network, a physical transmission path, and a network.

The Non-RT RIC 200 and the Near-RT RIC 100 are communicably connected via an Al interface. The Near-RT RIC 100 and the E2 node 300 are connected via an E2 interface. The Al interface and the E2 interface are interfaces for mainly transmitting and receiving data and messages necessary for control.

The E2 node 300 is a node constituting the RAN and includes an O-RAN Distributed Unit (O-DU) and an O-RAN Central Unit (O-CU). Note that either or both of the O-DU and the O-CU may be referred to as the E2 node 300. The RAN is a wireless network accessed by user equipment (UE), and is connected to a core network such as a 5G Core Network (5GC) or an Evolved Packet Core (EPC). The RAN may include an O-RAN Remote Unit (O-RU) constituting an antenna. The UE is a terminal device that is connected to the RAN and performs radio communication, and may be a mobile phone, a smartphone, a tablet terminal, an Internet of Things (IoT) terminal, or the like. In addition, the UE may be an application apparatus such as a robot, a drone, or an autonomous vehicle that implements a function of a terminal.

The E2 node 300 including the O-DU and the O-CU provides a base station function. The base station is, for example, a next Generation Node B (gNB) or an evolved Node B (eNB), but is not limited thereto. Note that the O-DU and the O-CU are examples of nodes that provide the base station function, and may be other network nodes.

The O-DU is a logical node that provides a radio signal control function and a layer 2 control function of the base station. The O-DU accommodates the O-RU and performs control of a radio signal (beam) of an antenna in the O-RU to the accommodated O-RU and protocol processing such as Media Access Control (MAC) or Radio Link Control (RLC) necessary between the O-RU and the O-CU.

The O-CU is a logical node that provides a radio resource control function of the base station and a data processing function higher than the layer 2. The O-CU accommodates the O-DU and performs data transmission/reception via the O-DU to accommodate the O-DU, Quality of Service (QOS) control, cell/UE management, handover control, and protocol processing such as Packet Data Convergence Protocol (PDCP), Service Data Adaptation Protocol (SDAP), and Radio Resource Control (RRC) necessary between the O-DU and the core network.

The E2 node 300 may include any number of O-DUs and O-CUs of 1 or more. That is, a plurality of base stations may be included. The O-DU and the O-CU are not necessarily the same number. The O-DU and the O-CU may be disposed at different locations, or may be disposed at the same location. In addition, the O-DU and the O-CU may be implemented by different virtual machines operating on the virtualization infrastructure of the edge, or the same virtual machine. The O-DU and the O-CU may be a virtualized Distributed Unit (vDU) and a virtualized Central Unit (vCU), and may constitute a virtual base station. The O-DU and the O-CU may be physical DU and CU. In addition, the E2 node 300 may be a base station apparatus including functions of an O-DU and an O-CU.

The Near-RT RIC 100 is a logical function that controls and optimizes the RAN in near real time. The Near-RT RIC 100 controls the RAN with a short control cycle of, for example, 10 ms (milliseconds: the same applies hereinafter) or more and less than 1 s (seconds: the same applies hereinafter). The Near-RT RIC 100 collects and analyzes radio information from the E2 node 300 including either or both of the O-DU and the O-CU via the E2 interface, and controls the E2 node 300 according to the radio information. The Near-RT RIC 100 includes a machine learning model that is a trained model, and analyzes the radio information and identifies control of the RAN by the machine learning model. For example, the Near-RT RIC 100 performs control according to the radio information in accordance with a control policy acquired from the Non-RT RIC 200 via the A1 interface. The control policy is a policy related to control of the RAN, and is, for example, an A1 policy. The Al policy is guidance for RAN optimization defined in the A1 interface. The Near-RT RIC 100 is disposed at the same location as either or both of the O-DU and the O-CU, or at a location near either or both of the O-DU and the O-CU. For example, the Near-RT RIC 100 may be implemented in a virtual machine of the same edge as either or both of the O-DU and the O-CU.

The Non-RT RIC 200 is a logical function that controls and optimizes the RAN in non-real time. The Non-RT RIC 200 controls the RAN with a long control cycle of, for example, 1 s or more. The Non-RT RIC 200 manages a control policy, manages operations of the E2 node 300 and the Near-RT RIC 100, learns (trains) and updates a machine learning model, and the like. For example, the Non-RT RIC 200 generates a control policy and notifies the Near-RT RIC 100 of the generated control policy via the Al interface. In addition, the Non-RT RIC 200 manages and sets configuration information (Configuration) of the E2 node 300 based on data acquired from the E2 node 300 or the Near-RT RIC 100 via the O1 interface. The Non-RT RIC 200 is disposed in a Service Management and Orchestration (SMO) that manages and orchestrates the RAN. The SMO is located at a location remote from the E2 node 300, the Near-RT RIC 100, for example, on the cloud. Note that the Non-RT RIC 200 may include a function of SMO.

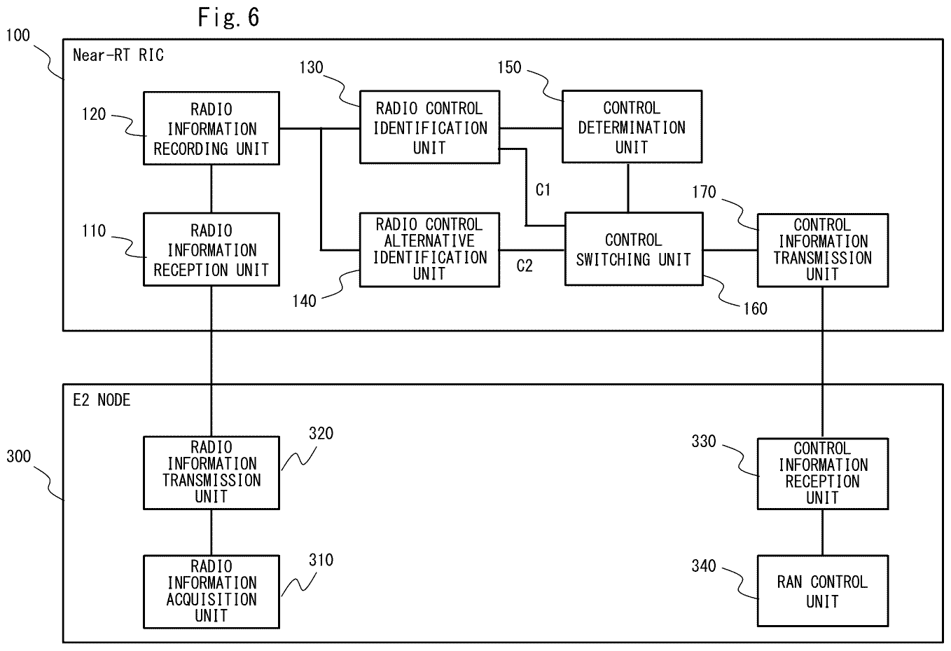

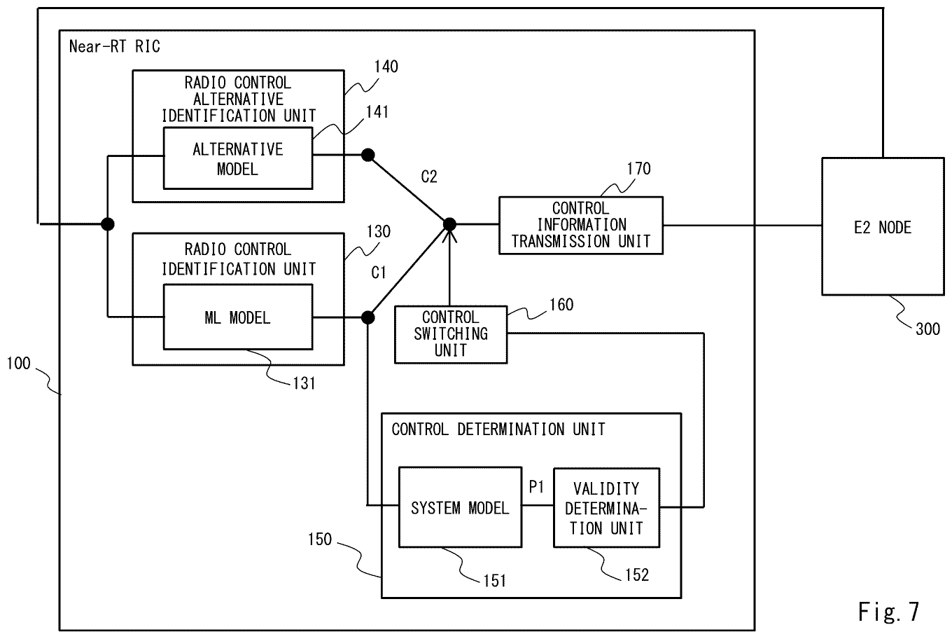

FIG. 6 illustrates a basic configuration example of the Near-RT RIC 100 and the E2 node 300 according to the present example embodiment, and FIG. 7 illustrates a specific configuration example of the Near-RT RIC 100. In FIG. 7, illustration of a part of the configuration illustrated in FIG. 6 is omitted. Note that the configuration is an example, and another configuration may be used as long as the operation according to the present example embodiment described below can be performed. A part of the configuration of the Near-RT RIC 100 may be disposed in the Non-RT RIC 200. For example, a control determination unit 150 may be disposed in the Non-RT RIC 200. As a result, the processing load can be distributed.

As illustrated in FIG. 6, the E2 node 300 includes a radio information acquisition unit 310, a radio information transmission unit 320, a control information reception unit 330, and a RAN control unit 340.

The radio information acquisition unit 310 acquires radio information of the RAN. The radio information acquisition unit 310 acquires information stored in the O-DU or the O-CU or radio information from the UE or the O-RU according to an instruction from the Near-RT RIC 100. The radio information acquisition unit 310 acquires, for example, wireless quality information collected from the UE as the radio information. For example, the wireless quality information is a Wideband Channel Quality Indicator (CQI) or the like. In addition, the radio information including the wireless quality information may be a Subband CQI, a Signal to Interference plus Noise power Ratio (SINR), a Reference Signal Received Power (RSRP), a Reference Signal Received Quality (RSRQ), a Received Signal Strength Indicator (RSSI), a Block Error Rate (BLER), a use record of a Modulation and Coding Scheme (MCS) index, a Rank Indicator (RI), a multiplicity of a Multi Input Multi Output (MIMO) actually used, or the like.

The radio information transmission unit 320 transmits the radio information acquired by the radio information acquisition unit 310 to the Near-RT RIC 100 via the E2 interface. For example, the radio information transmission unit 320 transmits radio information in response to an instruction from the Near-RT RIC 100.

The control information reception unit 330 receives the control information from the Near-RT RIC 100 via the E2 interface. The control information is radio control information for controlling the RAN according to the radio information, and is, for example, an MCS for each UE, a radio resource allocation priority, a parameter of handover control or beam control, or the like. In addition, the control information may be the MIMO multiplicity, the transmission frequency and timing of the reference signal, the frequency, timing, and type (indicating which table is used among three types of CQI tables) of the measurement information (Channel State Information (CSI) report), whether or not the PDCP duplication is used, Bandwidth Part (indicating which BWP is used in a case where there are a plurality of available BWPs), or the like. The RAN control unit 340 controls the RAN based on the received control information. For example, the MCS and the radio resource allocation priority of each UE included in the received control information are set to a MCS control unit and a radio resource control unit in the O-DU and the O-CU.

Furthermore, as illustrated in FIG. 6, the Near-RT RIC 100 includes a radio information reception unit 110, a radio information recording unit 120, a radio control identification unit 130, a radio control alternative identification unit 140, a control determination unit 150, a control switching unit 160, and a control information transmission unit 170.

The radio information reception unit 110 receives the radio information from the E2 node 300 including either or both of the O-DU and the O-CU via the E2 interface. The radio information reception unit 110 collects the radio information from the E2 node 300 as identification data used for identifying the control information by the radio control identification unit 130 and the radio control alternative identification unit 140. For example, the radio information reception unit 110 may instruct the E2 node 300 on the data to be collected and the cycle.

The radio information recording unit 120 is a database that records, that is, stores the radio information received from the E2 node 300. The radio information recording unit 120 accumulates the radio information as time-series data. The radio information reception unit 110 may output the received radio information to the radio control identification unit 130 and the radio control alternative identification unit 140.

The radio control identification unit 130 identifies the control information C1 for controlling the E2 node 300 including either or both of the O-DU and the O-CU based on the radio information received from the E2 node 300 using the radio information reception unit 110 and recorded in the radio information recording unit 120. The identified control is control of operation of the RAN, and is control of a radio resource allocation scheduler, a beam, a handover, and the like that can be performed by setting the O-DU or the O-CU. For example, the radio control identification unit 130 predicts future wireless quality around the UE from the wireless quality, and identifies the control information C1 including the MCS and the radio resource allocation priority for each UE configured in the E2 node 300 according to the predicted wireless quality.

Furthermore, as illustrated in FIG. 7, the radio control identification unit 130 includes an ML model 131 that identifies the control information C1. The radio control identification unit 130 inputs the radio information collected from the E2 node 300 to the ML model 131, and identifies the control information C1 of the E2 node 300 according to the radio information. The ML model 131 is a trained model obtained by machine learning of control information according to radio information. The ML model 131 is, for example, a first identification model stored in the storage unit of the Near-RT RIC 100. The ML model 131 is a machine learning model that identifies, that is, infers the control information C1 that controls the E2 node 300 including either or both of the O-DU and the O-CU according to the radio information. The ML model 131 is, for example, a model capable of analyzing and predicting time-series data. The ML model 131 may be a Convolutional Neural Network (CNN), a Recurrent Neural Network (RNN), a Long-Short Term Model (LSTM), or another neural network. The ML model 131 is not limited to the neural network, and may be another machine learning model.

The radio control alternative identification unit 140 identifies the control information C2 for controlling the E2 node 300 instead of the radio control identification unit 130. Similarly to the radio control identification unit 130, the radio control alternative identification unit 140 identifies the control information C2 for controlling the E2 node 300 based on the radio information received from the E2 node 300 using the radio information reception unit 110 and recorded in the radio information recording unit 120.

As illustrated in FIG. 7, the radio control alternative identification unit 140 includes an alternative model 141 that identifies the control information C2. The radio control alternative identification unit 140 inputs the radio information collected from the E2 node 300 to the alternative model 141, and identifies the control information C2 of the E2 node 300 according to the radio information. The alternative model 141 is, for example, a second identification model stored in the storage unit of the Near-RT RIC 100. Similarly to the ML model 131, the alternative model 141 is any model that can identify the control of the E2 node 300 including either or both of the O-DU and the O-CU according to the radio information.

For example, the alternative model 141 is a model with higher reliability than the ML model 131. That is, the alternative model 141 can output more stable control information than the ML model 131. Note that the alternative model 141 only needs to be able to output stable control information, and thus may output control information with lower accuracy than the ML model 131, for example. The alternative model 141 may identify the control information based on a predetermined rule or a predetermined algorithm.

In one example, the alternative model 141 may identify control information for controlling the MCS to be a fixed target BLER for each communication requirement. For example, a correspondence table in which the target BLER is associated with each requirement is set in advance such as the target BLER 10% in a case where the requirement of the communication delay is 100 ms and the target BLER 1% in a case where the requirement of the communication delay is 10 ms, and the control information is identified according to the value of the correspondence table. For example, in the case of the target BLER 10%, the MCS may be set according to the CQI notified from the UE, and in the case of the target BLER 1%, the MCS Index may be lowered such that the BLER becomes 1% based on the value of the CQI reported from the UE.

In other examples, the alternative model 141 may identify the control information such that the radio resource allocation priorities for all UEs are the same. As a result, the E2 node 300 performs the radio resource allocation operation according to the Proportional Fairness scheduling usually used in the base station.

In still other examples, the alternative model 141 may identify the control information by performing theoretical calculations or simulations corresponding to the RAN. For example, the alternative model 141 may perform simulation with some control parameters, calculate values of a retransmission rate (BLER) and a queuing delay, and identify the best parameter as the control information.

Furthermore, the alternative model 141 may be a trained model obtained by machine learning of control information according to radio information, similarly to the ML model 131. For example, the ML model 131 may be a specialized model specialized for a specific environment, and the alternative model 141 may be a general-purpose model capable of corresponding to an arbitrary environment. The specialized model is, for example, a model in which a relationship between radio information and control information in a specific base station, a specific region, or the like is trained and adapted to local characteristics. The general-purpose model is, for example, a model that trains a relationship between radio information and control information in many base stations and a wide area. For example, the ML model 131 may be a model that trains the control information according to the radio information acquired only from the RAN to be controlled, and the alternative model 141 may be a model that trains the control information according to the radio information acquired from the RAN including the others. Furthermore, the ML model 131 may be a short-term characteristic tracking type model in which the relationship between the radio information and the control information is trained in a short period, that is, in a predetermined period, and the alternative model 141 may be a long-term general-purpose type model in which the relationship between the radio information and the control information is trained in a long period, that is, in a period longer than the predetermined period. For example, the alternative model 141 may be a model in which a predetermined algorithm is incorporated, that is, a model before training applied at the time of system introduction. In addition, the alternative model 141 may be a model selected as a model that measures in advance the performance of a plurality of trained models trained in different environments and generates the most stable control information.

The control determination unit 150 determines the validity of the control information C1 identified and output from the radio control identification unit 130. The control determination unit 150 predicts communication performance of the RAN in a case where the RAN (E2 node) is controlled by the control information C1 identified by the ML model 131, and determines the validity of the control information C1 based on the predicted communication performance. The determination of the validity of the control information C1 is also to determine the validity of the operation (behavior) of the ML model 131 that has identified the control information C1. Note that, in this example, the validity of the control information C1 is determined, but the validity of the control information C1 and the control information C2 may be determined, and more appropriate control information, for example, control information with a shorter delay time may be output as the determination result. Furthermore, not limited to the two models of the ML model 131 and the alternative model 141, the most appropriate control information may be determined from the control information identified by three or more models.

Furthermore, as illustrated in FIG. 7, the control determination unit 150 includes a system model 151 and a validity determination unit 152. The control determination unit 150 inputs the control information C1 identified and output by the ML model 131 to the system model 151, and predicts a performance index P1 according to the control information C1. The system model 151 is, for example, a prediction model stored in a storage unit of the Near-RT RIC 100. The system model 151 is an arbitrary model capable of predicting the performance index according to the control information. For example, the performance index may be a BLER (retransmission rate), a queuing delay (queuing amount), or the like, a delay time according to the BLER or the queuing amount, a throughput, a frequency utilization efficiency (physical resource block (PRB) utilization rate), or the like.

The system model 151 may predict the performance index based on a predetermined rule or a predetermined algorithm. For example, the system model 151 may calculate the performance index P1 by theoretically calculating or simulating the operation of the RAN including the E2 node 300. For example, the simulation is performed based on the control information C1, and BLER, queuing delay, and the like are calculated. The system model 151 may identify the performance index P1 based on a predetermined rule such as a correspondence table in which the control information and the performance index are associated in advance. The system model 151 may be a trained model obtained by machine learning of the performance index according to the control information.

The validity determination unit 152 determines the validity of the performance index Pl predicted by the system model 151. For example, a threshold value in a predetermined range is set, and the validity is determined based on whether the performance index Pl is within the predetermined range. For example, the threshold value for determining the validity may be set from the Non-RT RIC 200. The validity determination unit 152 outputs the determination result of the validity to the control switching unit 160.

The control switching unit 160 switches (selects) the control information to be transmitted to the E2 node 300, that is, the control information for controlling the RAN according to the determination result of the validity of the control information C1 by the control determination unit 150 (validity determination unit 152). The control switching unit 160 selects the control information C1 as the control information to be transmitted to the E2 node 300 in a case where it is determined that the control information C1 identified by the radio control identification unit 130 is valid, and selects the control information C2 identified by the radio control alternative identification unit 140 as the control information to be transmitted to the E2 node 300 in a case where it is determined that the control information C1 is invalid.

The control information transmission unit 170 transmits the control information C1 identified by the radio control identification unit 130 or the control information C2 identified by the radio control alternative identification unit 140 to the E2 node 300 according to the switching of the control switching unit 160. The control information transmission unit 170 transmits the control information selected by the control switching unit 160 to the E2 node 300 including either or both of the O-DU and the O-CU via the E2 interface.

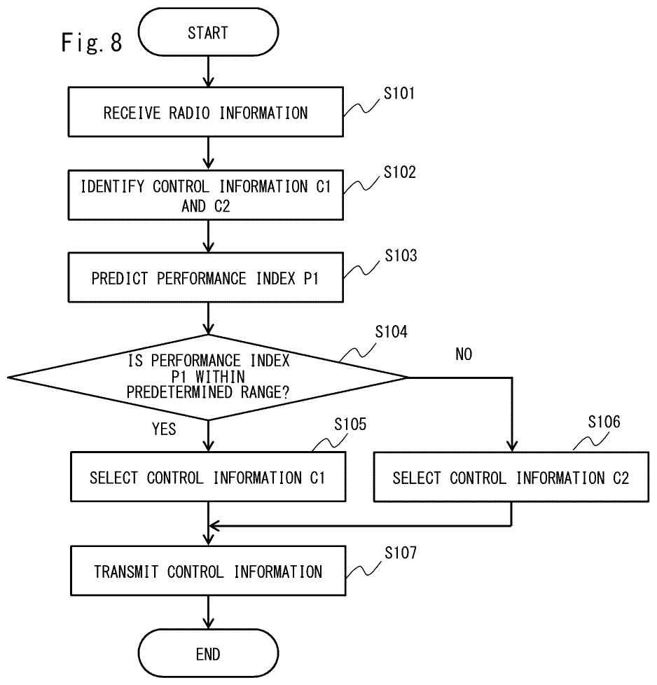

FIG. 8 illustrates an operation example of the Near-RT RIC 100 according to the present example embodiment. As illustrated in FIG. 8, the Near-RT RIC 100 receives the radio information from the E2 node 300 (S101). The radio information reception unit 110 receives the radio information such as a Wideband CQI from the E2 node 300 via the E2 interface. The radio information recording unit 120 records the radio information received from the E2 node 300.

Subsequently, the Near-RT RIC 100 identifies the control information C1 and C2 based on the received radio information (S102). The radio control identification unit 130 identifies the control information C1 according to the radio information using the ML model 131. In addition, the radio control alternative identification unit 140 identifies the control information C2 according to the radio information using the alternative model 141. The processing of identifying the control information C2 by the radio control alternative identification unit 140 is not limited to S102, and may be executed at any timing from S102 to S106.

For example, in an example of performing delay control, the radio control identification unit 130 and the radio control alternative identification unit 140 identify control information for controlling a retransmission delay and a queuing delay included in a factor of the delay. The retransmission delay is a delay caused by retransmission of data, and the queuing delay is a delay caused by queuing of transmission data in a transmission queue. For example, an MCS (target BLER) may be identified in order to control a retransmission delay, or a radio resource allocation priority to the UE, for example, a priority according to an allocation ratio of radio resources or a stay time in a transmission queue may be identified in order to control a queuing delay.

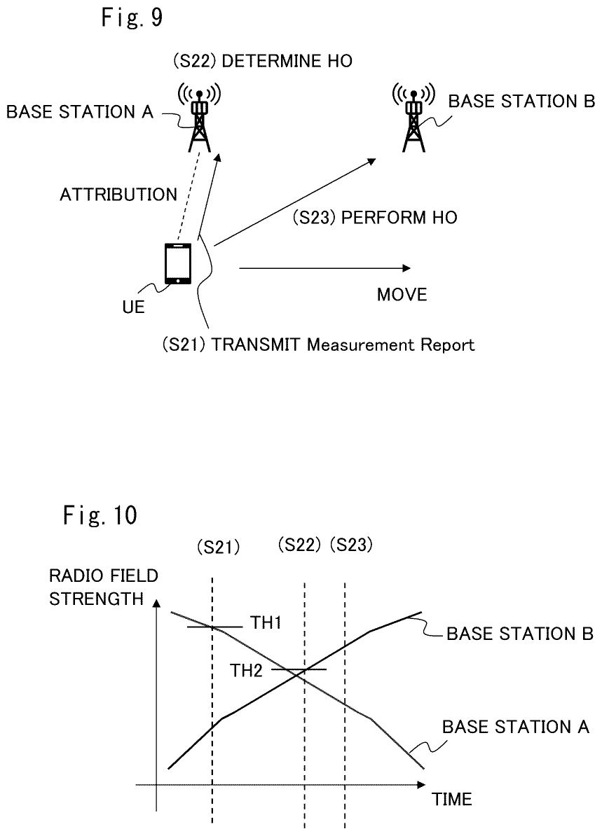

In addition, as another example, handover control may be performed. FIGS. 9 and 10 illustrate examples of the handover control. FIG. 9 illustrates the handover procedure (S21 to S23), and FIG. 10 illustrates a radio field strength in the UE at each time corresponding to S21 to S22. As illustrated in FIGS. 9 and 10, in S21, the UE starts transmission of the measurement report indicating radio wave quality information of the attributed cell (base station A) and the neighboring cell (base station B) in a case where the radio field strength of the belonging base station A deteriorates to the predetermined threshold value TH1 or less. Next, in S22, the base station A determines to perform the handover based on the radio wave quality information indicated by the measurement report transmitted from the UE and a predetermined threshold value TH2, and instructs the UE to perform the handover to the base station B in a case where it is determined that the handover needs to be performed. Next, in S23, the UE performs the handover to the base station B instructed by the base station A.

In such an example of the handover control, the radio control identification unit 130 and the radio control alternative identification unit 140 may identify a trigger threshold value TH1 at which the UE starts to transmit the measurement report as the control information. For example, the threshold value TH1 is a threshold value for a value of radio wave quality (RSRP (Reference Signal Received Power) and RSRQ (Reference Signal Received Quality)) of an attributed station or a value of a difference from an adjacent cell. In addition, as the control information, a Neighbor Cell Relation Table (NCRT) which is adjacent cell information may be identified. By identifying the neighboring cell information, it is possible to narrow the neighboring cell whose radio wave quality is reported in the measurement report. By identifying adjacent cell information by using a movement pattern (handover pattern) or the like, it is possible to exclude a base station in which no handover has occurred in the past from candidates. In addition, the threshold value TH2 at which the base station determines to perform the handover may be identified as the control information. For example, the threshold value TH2 is a threshold value for a value of radio wave quality (RSRP, RSRQ) of an attributed station or a value of a difference from an adjacent cell.

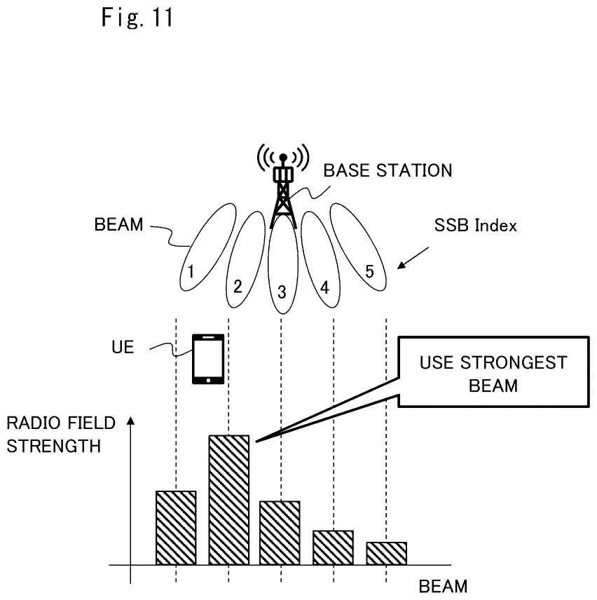

As another example, beam control may be performed. FIG. 11 illustrates an example of the beam control. As illustrated in FIG. 11, a plurality of beams is transmitted from one base station. By forming a beam, a cell radius can be widened, and use in a high frequency band is particularly assumed. Reference signals corresponding to a plurality of beams are included in a Synchronization Signal (SS) block and transmitted from the base station. Each reference signal includes an SSB index that is an identifier of a beam. The UE measures the intensity of each beam and reports the intensity to the base station. The base station instructs the UE to use a strongest beam, and then adjusts directivities of antennas of the base station and the UE by using a CSI-RS that is a reference signal sent for each UE, so that the directivities are adjusted to face each other. Beams facing each other are referred to as beam-pairs. In a case where the UE moves and the intensity of beams with other SSB indexes becomes strong, the UE reports the fact to the base station through a CSI-Report, and the base station determines beam switching by a predetermined threshold value and switches the beams.

In such an example of the beam control, the radio control identification unit 130 and the radio control alternative identification unit 140 may identify the direction of the beam included in the SSB transmitted by the base station as the control information. In addition, as the control information, a beam intensity report frequency and timing by the SI-Report of the UE may be identified. There are periodic and aperiodic in the CSI-Report, and the period can be controlled in the case of periodic, and the report timing can be controlled in the case of aperiodic. In addition, a threshold value for beam switching determination by the base station may be identified as the control information. For example, the threshold value is a value or a difference of radio field strength for each beam.

Subsequently, the Near-RT RIC 100 predicts the performance index P1 based on the identified control information C1 (S103). The control determination unit 150 predicts the performance index P1 (performance index value) in a case where the E2 node 300 uses the control information C1 by using the system model 151.

For example, in an example of performing the delay control, the system model 151 may predict BLER (retransmission rate) related to a retransmission delay as a performance index, or may predict a queuing amount of a transmission queue related to a queuing delay. The queuing amount may be one in which the queuing amount can be estimated, such as a short-term throughput average and a long-term throughput average. The system model 151 may predict the delay time according to the BLER or the queuing amount.

In addition, in the example of performing the handover control illustrated in FIGS. 9 and 10, the system model 151 may predict a time required for the handover, an event such as a Handover Failure (Radio Link Failure: RLF) or a Ping-Pong, and a radio wave quality value after the handover as the performance index. The system model 151 may predict the time required for the handover according to each event and the radio wave quality value.

Furthermore, in the example of performing the beam control illustrated in FIG. 11, the system model 151 may predict an event of Beam-Failure due to loss of Beam-pair, an event such as Ping-Pong, and the radio wave quality value after beam switching as the performance index. The system model 151 may predict the time required for beam switching according to each event and the radio wave quality value.

Subsequently, the Near-RT RIC 100 determines whether the predicted performance index P1 is within a predetermined range (S104). The validity determination unit 152 determines whether or not the performance index P1 predicted from the control information C1 by the system model 151 is within a predetermined range.

The Near-RT RIC 100 selects the control information C1 in a case where the predicted performance index P1 is within a predetermined range (S105), and selects the control information C2 in a case where the predicted performance index P1 is outside the predetermined range (S106). In a case where the performance index P1 predicted from the control information C1 is within the predetermined range, the control switching unit 160 inputs the control information C1 identified by the ML model 131 to the control information transmission unit 170, and in a case where the performance index P1 predicted from the control information C1 is out of the predetermined range, the control switching unit switches to input the control information C2 identified by the alternative model 141 to the control information transmission unit 170.

Subsequently, the Near-RT RIC 100 transmits the control information to the E2 node 300 (S107). The control information transmission unit 170 transmits either the selected control information C1 or C2 to the E2 node 300 via the E2 interface. Thereafter, S101 to S107 are repeatedly executed. For example, even in a case where the control information to be transmitted is switched from the control information C1 to the control information C2, the control information to be transmitted is returned to the control information C1 in a case where the control information C1 becomes an appropriate value thereafter.

As described above, in the present example embodiment, the control information identified by the machine learning model is input to the system model of the wireless communication, the performance index related to the wireless quality is calculated by theoretical calculation or simulation, and the validity of the control information is determined based on the calculated performance index. In a case where the control information is determined to be invalid, the control information is switched to the identified control information using an alternative model based on a predetermined rule or theory. As a result, even in a case where the machine learning model takes an unstable behavior, stable wireless control can be performed, and deterioration in quality of wireless communication can be suppressed.

### Second Example Embodiment

Next, a second example embodiment will be described. In the present example embodiment, an example of correcting a parameter of a system model for determining validity of control information by a performance index collected from an E2 node will be described. Note that the present example embodiment can be implemented in combination with the first example embodiment, and each component described in the first example embodiment may be appropriately used.

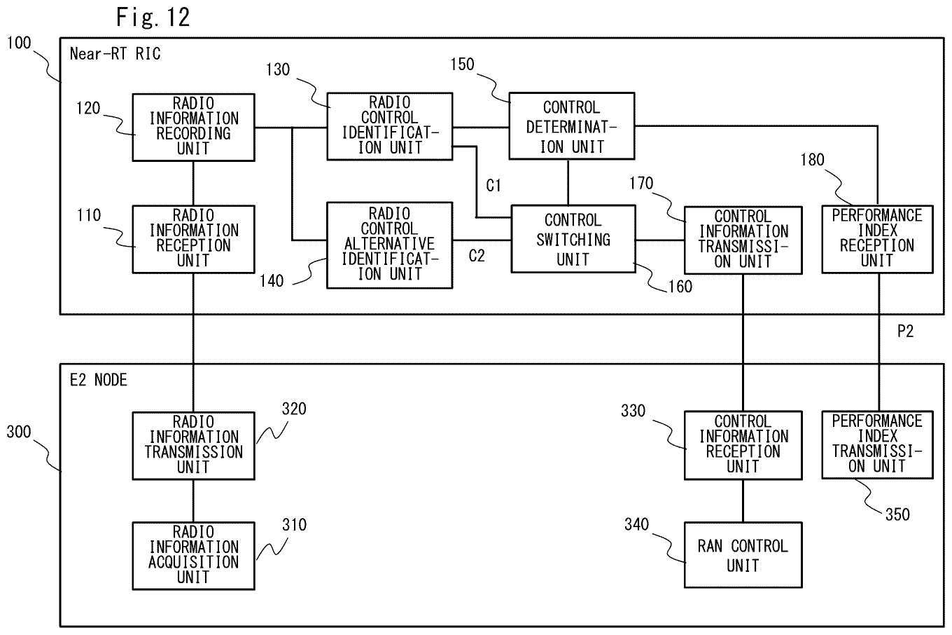

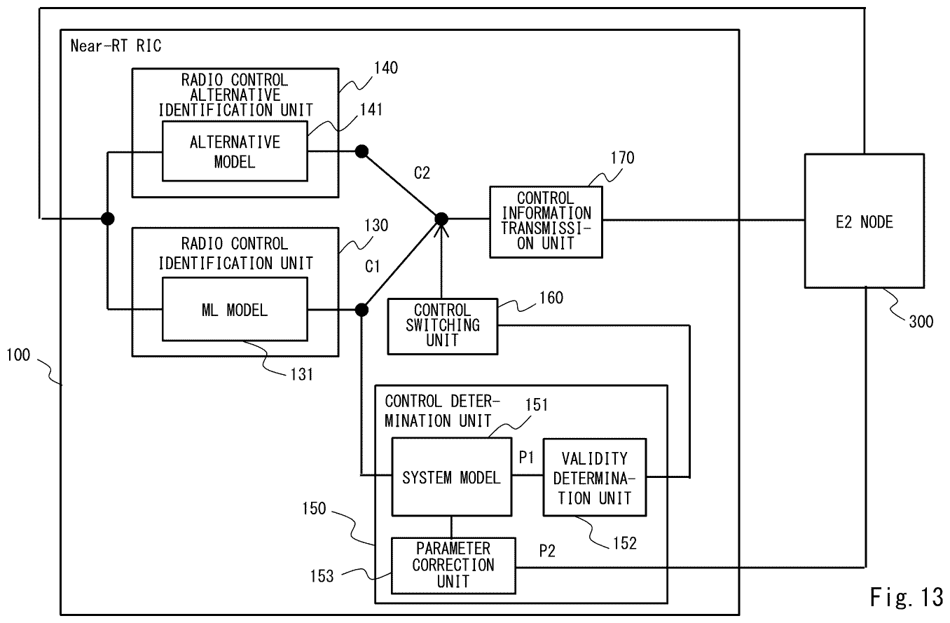

FIG. 12 illustrates a basic configuration example of the Near-RT RIC 100 and the E2 node 300 according to the present example embodiment, and FIG. 13 illustrates a specific configuration example of the Near-RT RIC 100. In FIG. 13, illustration of a part of the configuration illustrated in FIG. 12 is omitted.

As illustrated in FIG. 12, the E2 node 300 according to the present example embodiment includes a performance index transmission unit 350 in addition to the configuration of the first example embodiment. The performance index transmission unit 350 transmits the performance index P2 to the Near-RT RIC 100 via the E2 interface. The performance index transmission unit 350 acquires or measures the performance index P2 based on information stored in the O-DU or the O-CU or information collected from the UE or the O-RU, and transmits the acquired or measured performance index P2 (performance index value) to the Near-RT RIC 100. For example, after the RAN control unit 340 performs control based on the control information received from the Near-RT RIC 100, the performance index transmission unit 350 transmits the performance index as a result of the actual control. The performance index P2 to be acquired and transmitted may be instructed from the Near-RT RIC 100 or may be registered in the E2 node 300.

The performance index P2 is a performance index that can be observed at least in the RAN. For example, similarly to the performance index Pl described in the system model 151 of the first example embodiment, the performance index P2 is an actual value of BLER or MCS, a queuing amount, or the like in an example in which delay control is performed, a time required for handover, an event such as Handover Failure or Ping-Pong, a radio wave quality value after handover, or the like in an example in which handover control is performed, and is an event of Beam-Failure due to loss of Beam-pair, an event such as Ping-Pong, a radio wave quality value after beam switching, or the like in an example in which beam control is performed.

As illustrated in FIG. 12, the Near-RT RIC 100 according to the present example embodiment includes a performance index reception unit 180 in addition to the configuration of the first example embodiment. The performance index reception unit 180 receives the performance index P2 from the E2 node 300 including either or both of the O-DU and the O-CU controlled by the control information via the E2 interface. The performance index reception unit 180 outputs the received performance index P2 to the control determination unit 150.

As illustrated in FIG. 13, the control determination unit 150 according to the present example embodiment includes a parameter correction unit 153 in addition to the configuration of the first example embodiment. The parameter correction unit 153 corrects a parameter of the system model 151 based on the performance index P2 acquired from the E2 node 300. The parameter correction unit 153 matches (calibrates) an internal parameter used to calculate the performance index P1 in the system model 151 with the performance index P2 which is an actual measurement value. For example, the internal parameter is a parameter or the like in a predetermined mathematical expression used in the operation of the system model 151. In a case where the control information is input to the system model 151, the parameter correction unit 153 corrects the parameter so as to output the performance index that is the same as the actual measurement value or close to the actual measurement value. For example, the correction may be performed using Bayesian estimation, a Kalman filter, or the like. Other configurations are similar to those in the first example embodiment.

As described above, in addition to the configuration of the first example embodiment, the actual performance index may be collected from the E2 node, and the parameter of the system model may be corrected based on the collected performance index. As a result, since the prediction accuracy of the performance index by the system model is improved, the validity of the control information can be more accurately determined.

### Third Example Embodiment

Next, a third example embodiment will be described. In the present example embodiment, an example in which the performance index predicted by the ML model is verified by the performance index collected from the E2 node will be described. Note that the present example embodiment can be implemented in combination with the first or second example embodiment, and each configuration described in the first or second example embodiment may be appropriately used.

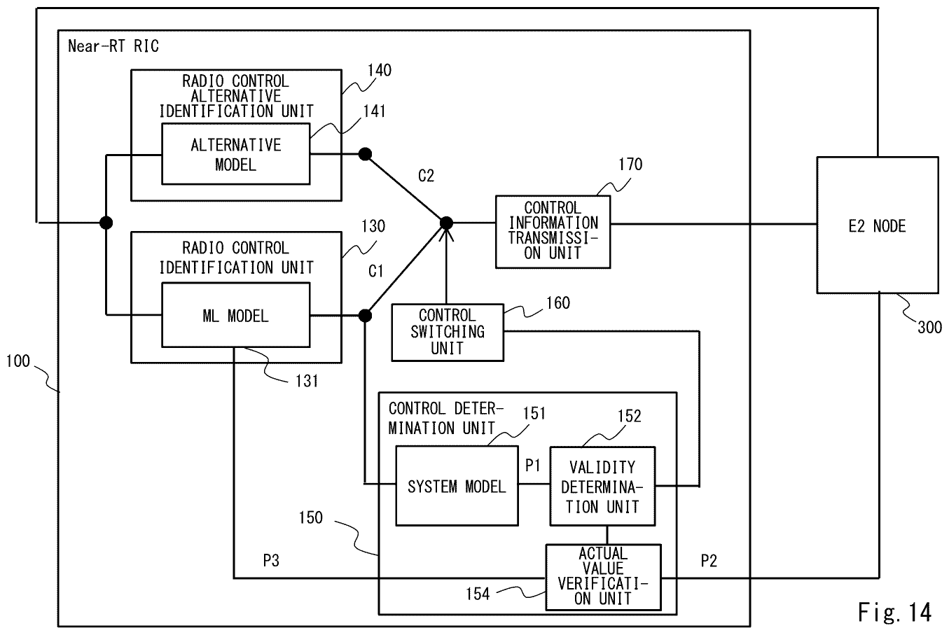

For example, a basic configuration example of the Near-RT RIC 100 and the E2 node 300 according to the present example embodiment is similar to that of FIG. 12 of the second example embodiment, and FIG. 14 illustrates a specific configuration example of the Near-RT RIC 100 according to the present example embodiment. In FIG. 14, illustration of a part of the configuration illustrated in FIG. 12 is omitted.

As illustrated in FIG. 14, in the present example embodiment, the ML model 131 predicts and outputs the performance index P3. That is, the ML model 131 identifies the control information C1 according to the input radio information and predicts the performance index P3 of the RAN according to the control information C1. The ML model 131 is a trained model trained to generate the control information C1 and the performance index P3 according to the radio information. Similarly to the performance index P2 acquired from the E2 node 300, the performance index P3 is a performance index observable by the RAN.

In addition, the control determination unit 150 according to the present example embodiment includes an actual value verification unit 154 in addition to the configuration of the first example embodiment. The actual value verification unit 154 compares the performance index P3 (performance index value) predicted by the ML model 131 with the performance index P2 (performance index value) that is the actual value (actual measurement value) acquired from the E2 node 300, and verifies the predicted performance index P3. For example, the actual value verification unit 154 obtains a difference between the predicted performance index P3 and the acquired performance index P2, and determines whether the difference is within a predetermined range. In a case where the difference falls within the predetermined range, it is determined that the performance index P3 and the performance index P2 match each other, and in a case where the difference falls outside the predetermined range, it is determined that the performance index P3 and the performance index P2 do not match each other.

As in the first example embodiment, the validity determination unit 152 determines the performance index Pl calculated by the system model 151 from the control information C1 and determines validity from the verification result of the actual value verification unit 154. In this case, the validity to be determined is the validity of the control information C1 and also the validity of the ML model 131 that has generated the control information C1. For example, in a case where the predicted performance index P3 matches the acquired performance index P2, it may be determined to be appropriate, and in a case where the predicted performance index P3 does not match the acquired performance index P2, it may be determined to be invalid. In a case where the performance index Pl calculated by the system model 151 falls within a predetermined range and the predicted performance index P3 matches the acquired performance index P2, the control information C1 may be determined to be valid, and in a case where the performance index P1 calculated by the system model 151 falls outside the predetermined range or the predicted performance index P3 does not match the acquired performance index P2, the control information C1 may be determined to be invalid. Other configurations are similar to those in the first example embodiment.

As described above, in addition to the configuration of the first example embodiment, the actual performance index may be collected from the E2 node, the performance index predicted by the ML model may be verified based on the collected performance index, and the validity of the control information identified by the ML model may be determined based on the verification result. As a result, it is possible to determine the validity of the control information identified by the ML model while verifying the performance index predicted by the ML model, and thus, it is possible to more accurately determine the validity of the control information.

### Fourth Example Embodiment

Next, a fourth example embodiment will be described. In the present example embodiment, an example in which determination of validity of control information is used for training of an ML model will be described. Note that the present example embodiment can be implemented in combination with any of the first to third example embodiments, and each configuration described in any of the first to third example embodiments may be appropriately used.

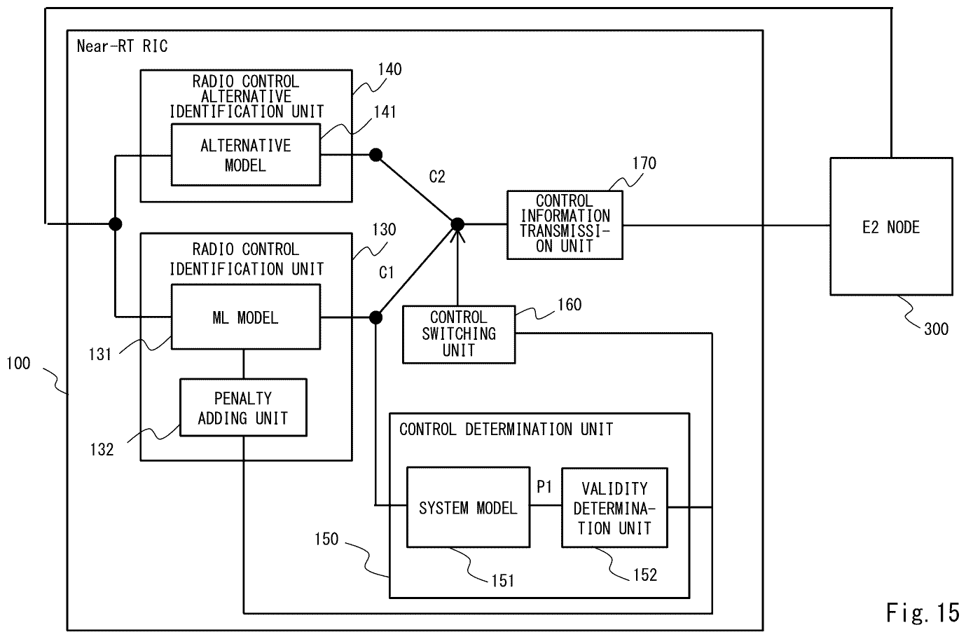

For example, a basic configuration example of the Near-RT RIC 100 and the E2 node 300 according to the present example embodiment is similar to that of FIG. 6 of the first example embodiment, and FIG. 15 illustrates a specific configuration example of the Near-RT RIC 100 according to the present example embodiment. In FIG. 15, illustration of a part of the configuration illustrated in FIG. 6 is omitted. Note that, in this example, since it is sufficient that the training operation of the ML model 131 can be performed, the control switching unit 160 and the control information transmission unit 170 may not be provided.

As illustrated in FIG. 15, the radio control identification unit 130 according to the present example embodiment includes a penalty adding unit 132 in addition to the configuration of the first example embodiment. The penalty adding unit 132 is a training unit that causes the ML model 131 to perform machine learning according to the determination result of the validity determination unit 152 at the time of training of the ML model 131. In a case where the control information C1 is determined to be invalid, the penalty adding unit 132 imposes a penalty on the control information C1 determined to be invalid. The ML model 131 trains to generate valid control information according to the radio information based on the penalty.

As described above, the determination result of validity in the first example embodiment may be used for training of the ML model. As a result, since the accuracy with which the ML model identifies the control information is improved, stable control information can be output.

Note that the present disclosure is not limited to the above-described example embodiments, and can be appropriately modified without departing from the scope.

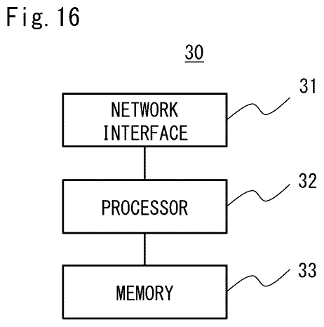

Each configuration in the above-described example embodiments may be implemented by hardware, software, or both, and may be implemented by one piece of hardware or software or by a plurality of pieces of hardware or software. Each apparatus including the Non-RT RIC and the Near-RT RIC and each function (processing) may be realized by a computer 30 including a network interface 31, a processor 32 such as a central processing unit (CPU), and a memory 33 which is a storage device as illustrated in FIG. 16. The network interface 31 may include a network interface card (NIC) for communicating with apparatuses including network nodes. For example, a program for performing the method (control method) in the example embodiment may be stored in the memory 33, and each function may be realized by executing the program stored in the memory 33 by the processor 32.

These programs include a group of commands (or software codes) causing a computer to perform one or more of the functions described in the example embodiments in a case of being read by the computer. The program may be stored in a non-transitory computer readable medium or a tangible storage medium. As an example and not by way of limitation, the computer readable medium or the tangible storage medium includes a random access memory (RAM), a read only memory (ROM), a flash memory, a solid-state drive (SSD) or any other memory technology, a CD-ROM, a digital versatile disc (DVD), a Blu-ray (registered trademark) disc or any other optical disk storage, a magnetic cassette, a magnetic tape, a magnetic disk storage, and any other magnetic storage device. The program may be transmitted through a transitory computer readable medium or a communication medium. By way of example, and not limitation, transitory computer-readable or communication media include electrical, optical, acoustic, or other forms of propagated signals.

Although the present disclosure has been described above with reference to the example embodiments, the present disclosure is not limited to the above-described example embodiments. It will be understood by those of ordinary skill in the art that various changes in form and details may be made therein without departing from the sprit and scope of the present disclosure as defined by the claims.

Some or all of the above-described example embodiments may be described as in the following Supplementary Notes, but are not limited to the following Supplementary Notes.

### Supplementary Note 1

A control system including:
a first identification means for identifying, by a first identification model, first control information for controlling a wireless network;
a second identification means for identifying, by a second identification model, second control information for controlling the wireless network;
a validity determination means for determining validity of the first control information according to communication performance of the wireless network predicted based on the first control information; and
a selection means for selecting control information for controlling the wireless network from the first control information and the second control information according to a determination result of the validity.

### Supplementary Note 2

The control system according to Supplementary Note 1, in which the second identification model is a model having a lower probability of outputting abnormal control information than the first identification model.

### Supplementary Note 3

The control system according to Supplementary Note 1 or 2, in which the first identification model is a training model obtained by machine learning of control information according to wireless quality information acquired from the wireless network.

### Supplementary Note 4

The control system according to any one of Supplementary Notes 1 to 3, in which the second identification model is a model that identifies the second control information based on a predetermined rule with respect to wireless quality information acquired from the wireless network.

### Supplementary Note 5

The control system according to any one of Supplementary Notes 1 to 3, in which the second identification model is a model that identifies the second control information by performing theoretical calculation or simulation corresponding to the wireless network on wireless quality information acquired from the wireless network.

### Supplementary Note 6

The control system according to any one of Supplementary Notes 1 to 3, in which the second identification model is a training model obtained by machine learning of control information according to wireless quality information acquired from the wireless network.

### Supplementary Note 7

The control system according to Supplementary Note 3, in which
the first identification model is a training model obtained by machine learning of control information according to wireless quality information acquired only from the wireless network, and
the second identification model is a training model obtained by machine learning of control information according to wireless quality information acquired from a wireless network including another wireless network.

### Supplementary Note 8

The control system according to Supplementary Note 3, in which
the first identification model is a training model obtained by machine learning of control information according to wireless quality information acquired from the wireless network for a predetermined period, and
the second identification model is a training model obtained by machine learning of control information according to wireless quality information acquired from the wireless network for a period longer than the predetermined period.

### Supplementary Note 9

The control system according to any one of Supplementary Notes 1 to 8, in which the validity determination means predicts communication performance of the wireless network according to the first control information by a prediction model.

### Supplementary Note 10

The control system according to Supplementary Note 9, in which the prediction model is a model that predicts the communication performance by performing theoretical calculation or simulation corresponding to the wireless network on the first control information.

### Supplementary Note 11

The control system according to Supplementary Note 9, in which the prediction model is a model that predicts the communication performance based on a predetermined rule with respect to the first control information.

### Supplementary Note 12

The control system according to Supplementary Note 9, in which the prediction model is a training model obtained by machine learning of communication performance according to the first control information.

### Supplementary Note 13

The control system according to any one of Supplementary Notes 9 to 12, in which the validity determination means corrects a parameter used by the prediction model to predict the communication performance based on the communication performance acquired from the wireless network.

### Supplementary Note 14

The control system according to any one of Supplementary Notes 1 to 13, in which
the first identification means further predicts communication performance of the wireless network by the first identification model, and
the validity determination means determines the validity based on the communication performance of the wireless network predicted by the first identification model and the communication performance acquired from the wireless network.

### Supplementary Note 15

The control system according to Supplementary Note 3, 7, or 8, including a training means for causing machine learning to be performed on a training model of the first identification model based on the determination result of the validity.

### Supplementary Note 16

The control system according to Supplementary Note 15, in which the training means penalizes the first control information in a case where the first control information is determined to be invalid.

### Supplementary Note 17

The control system according to any one of Supplementary Notes 1 to 16, in which the control system includes a Near-Real Time (RT) RAN Intelligent Controller (RIC) that controls a Radio Access Network (RAN) or a Non-RT RIC.

### Supplementary Note 18

The control system according to claim 17, in which
the Near-RT RIC includes the first identification means, the second identification means, and the selection means, and
the Non-RT RIC includes the validity determination means.

### Supplementary Note 19

A control apparatus including:
a first identification means for identifying, by a first identification model, first control information for controlling a wireless network;
a second identification means for identifying, by a second identification model, second control information for controlling the wireless network;
a validity determination means for determining validity of the first control information according to communication performance of the wireless network predicted based on the first control information; and
a selection means for selecting control information for controlling the wireless network from the first control information and the second control information according to a determination result of the validity.

### Supplementary Note 20

A control method including:
identifying, by a first identification model, first control information for controlling a wireless network;
identifying, by a second identification model, second control information for controlling the wireless network;
determining validity of the first control information according to communication performance of the wireless network predicted based on the first control information; and
selecting control information for controlling the wireless network from the first control information and the second control information according to a determination result of the validity.

### Supplementary Note 21

A non-transitory computer readable medium storing a control program for causing a computer to execute:
identifying, by a first identification model, first control information for controlling a wireless network;
identifying, by a second identification model, second control information for controlling the wireless network;
determining validity of the first control information according to communication performance of the wireless network predicted based on the first control information; and
selecting control information for controlling the wireless network from the first control information and the second control information according to a determination result of the validity.
RAN SYSTEM
10 CONTROL SYSTEM
11 FIRST IDENTIFICATION UNIT
12 SECOND IDENTIFICATION UNIT
13 VALIDITY DETERMINATION UNIT
14 SELECTION UNIT
20, 21, 22 CONTROL APPARATUS
30 COMPUTER
31 NETWORK INTERFACE
32 PROCESSOR
33 MEMORY
100 NEAR-RT RIC
110 RADIO INFORMATION RECEPTION UNIT
120 RADIO INFORMATION RECORDING UNIT
130 RADIO CONTROL IDENTIFICATION UNIT
131 ML MODEL
132 PENALTY ADDING UNIT
140 RADIO CONTROL ALTERNATIVE IDENTIFICATION UNIT
141 ALTERNATIVE MODEL
150 CONTROL DETERMINATION UNIT
151 SYSTEM MODEL
152 VALIDITY DETERMINATION UNIT
153 PARAMETER CORRECTION UNIT
154 ACTUAL VALUE VERIFICATION UNIT
160 CONTROL SWITCHING UNIT
170 CONTROL INFORMATION TRANSMISSION UNIT
180 PERFORMANCE INDEX RECEPTION UNIT
200 NON-RT RIC
300 E2 NODE
310 RADIO INFORMATION ACQUISITION UNIT
320 RADIO INFORMATION TRANSMISSION UNIT
330 CONTROL INFORMATION RECEPTION UNIT
340 RAN CONTROL UNIT
350 PERFORMANCE INDEX TRANSMISSION UNIT

What is claimed is:

1. A control system comprising:
a memory configured to store instructions, and
a processor configured to execute the instructions to;
identify, by a first identification model, first control information for controlling a wireless network;
a identify, by a second identification model, second control information for controlling the wireless network;
determine validity of the first control information according to communication performance of the wireless network predicted based on the first control information; and
select control information for controlling the wireless network from the first control information and the second control information according to a determination result of the validity.

2. The control system according to claim 1, wherein the second identification model is a model having a lower probability of outputting abnormal control information than the first identification model.

3. The control system according to claim 1, wherein the first identification model is a training model obtained by machine learning of control information according to wireless quality information acquired from the wireless network.

4. The control system according to claim 1, wherein the second identification model is a model that identifies the second control information based on a predetermined rule with respect to wireless quality information acquired from the wireless network.

5. The control system according to claim 1, wherein the second identification model is a model that identifies the second control information by performing theoretical calculation or simulation corresponding to the wireless network on wireless quality information acquired from the wireless network.

6. The control system according to claim wherein the second identification model is a training model obtained by machine learning of control information according to wireless quality information acquired from the wireless network.

7. The control system according to claim 3, wherein
the first identification model is a training model obtained by machine learning of control information according to wireless quality information acquired only from the wireless network, and
the second identification model is a training model obtained by machine learning of control information according to wireless quality information acquired from a wireless network including another wireless network.

8. The control system according to claim 3, wherein
the first identification model is a training model obtained by machine learning of control information according to wireless quality information acquired from the wireless network for a predetermined period, and
the second identification model is a training model obtained by machine learning of control information according to wireless quality information acquired from the wireless network for a period longer than the predetermined period.

9. The control system according to claim 1, wherein the processor is further configured to execute the instructions to predict communication performance of the wireless network according to the first control information by a prediction model.

10. The control system according to claim 9, wherein the prediction model is a model that predicts the communication performance by performing theoretical calculation or simulation corresponding to the wireless network on the first control information.

11. The control system according to claim 9, wherein the prediction model is a model that predicts the communication performance based on a predetermined rule with respect to the first control information.

12. The control system according to claim 9, wherein the prediction model is a training model obtained by machine learning of communication performance according to the first control information.

13. The control system according to claim 9, wherein the processor is further configured to execute the instructions to correct a parameter used by the prediction model to predict the communication performance based on the communication performance acquired from the wireless network.

14. The control system according to claim 1, wherein
the processor is further configured to execute the instructions to predict communication performance of the wireless network by the first identification model, and
determine the validity based on the communication performance of the wireless network predicted by the first identification model and the communication performance acquired from the wireless network.

15. The control system according to claim wherein the processor is further configured to execute the instructions to cause machine learning to be performed on a training model of the first identification model based on the determination result of the validity.

16. The control system according to claim 15, wherein the processor is further configured to execute the instructions to penalize the first control information in a case where the first control information is determined to be invalid.

17. The control system according to claim wherein the control system includes a Near-Real Time (RT) RAN Intelligent Controller (RIC) that controls a Radio Access Network (RAN) or a Non-RT RIC.

18. The control system according to claim 17, wherein
the Near-RT RIC performs the identifying by the first identification model, the identifying by the second identification model, and the selecting of the control information, and
the Non-RT RIC performs the determining of the validity of the first control information

19. A control apparatus comprising:
a memory configured to store instructions, and
a processor configured to execute the instructions to;
identify, by a first identification model, first control information for controlling a wireless network;
identify, by a second identification model, second control information for controlling the wireless network;
determine validity of the first control information according to communication performance of the wireless network predicted based on the first control information; and
select control information for controlling the wireless network from the first control information and the second control information according to a determination result of the validity.

20. A control method comprising:
identifying, by a first identification model, first control information for controlling a wireless network;
identifying, by a second identification model, second control information for controlling the wireless network;
determining validity of the first control information according to communication performance of the wireless network predicted based on the first control information; and
selecting control information for controlling the wireless network from the first control information and the second control information according to a determination result of the validity.

21. canceled
